(19) United States
(12) Patent Application Publication
(10) Pub. No.: US 2026/0311282 A1
(43) Pub. Date: Oct. 8, 2026

(54) Training system, method, storage medium, and device for the survey and design field

(71) Applicant: Shanghai Investigation, Design & Research Institute Co., Ltd., Shanghai (CN)

(72) Inventors: Zhanhui GAO, Shanghai (CN); Jiuding ZHANG, Shanghai (CN); Yihua ZHANG, Shanghai (CN); Jian'gang WANG, Shanghai (CN); Hui WEI, Shanghai (CN); Yan TENG, Shanghai (CN); Hui LIANG, Shanghai (CN); Rui TAN, Shanghai (CN); Xuan ZHOU, Shanghai (CN); Yuanyuan HU, Shanghai (CN); Yuchen GONG, Shanghai (CN); Dewei CAO, Shanghai (CN); Changyun QIAN, Shanghai (CN); Yang WANG, Shanghai (CN); Zhilin YIN, Shanghai (CN)

(73) Assignee: Shanghai Investigation, Design & Research Institute Co., Ltd., Shanghai (CN)

(21) Appl. No.: 18/842,809

(22) PCT Filed: Jan. 24, 2024
(86) PCT No.: PCT/CN2024/073848

§ 371 Date: May 24, 2026

(30) Foreign Application Priority Data
Dec. 28, 2023 (CN) 202311842387.0

(51) Int. Cl. G06Q 50/20; G06N 5/022; G06Q 10/0639

(52) U.S. Cl. CPC G06Q 50/2057; G06N 5/022; G06Q 10/0639

(57) ABSTRACT

A training system comprises a data collection module for obtaining learner data and training data in the survey and design field; a knowledge graph construction module for constructing a training knowledge graph based on the training data; a portrait generation module for generating learner portraits based on the learner data and course portraits based on the training courses in the survey and design field; and a training plan generation module for generating personalized training plans using an artificial intelligence model based on the learner portraits, course portraits, and the training knowledge graph. The training system is capable of generating personalized training plans with effective training outcomes.

### FIELD OF THE INVENTION

The present disclosure belongs to the technical field of survey and design, relates to a training system and method, and in particular to a training system, method, storage medium, and device for the survey and design field.

### BACKGROUND OF THE INVENTION

In the survey and design field, the acquisition and enhancement of professional knowledge require extensive practical experience and a solid accumulation of theoretical knowledge. However, the existing training methods for talent development primarily rely on the transmission of knowledge through text, images, or videos, which lack sufficient intuitiveness and result in less-than-expected learning outcomes. Additionally, traditional training methods have failed to effectively organize and present professional and management knowledge in the survey and design field, making it difficult for learners to build a comprehensive knowledge system.

### SUMMARY OF THE INVENTION

The present disclosure provides a training system, method, storage medium, and device for the survey and design field, aimed at offering personalized training for learners in this field.

In a first aspect, the present disclosure provides a training system for the survey and design field. The training system includes: a data collection module for obtaining learner data and training data in the survey and design field; a knowledge graph construction module for constructing a training knowledge graph based on the training data; a portrait generation module for generating learner portraits based on the learner data and course portraits based on the training courses in the survey and design field; and a training plan generation module for generating personalized training plans using an artificial intelligence model based on the learner portraits, course portraits, and the training knowledge graph.

In an embodiment of the first aspect, the training system further includes a data processing module for pre-processing the data collected by the data collection module.

In an embodiment of the first aspect, the training system further includes a visualization module for visualizing the learner portraits, course portraits, and/or the training knowledge graph.

In an embodiment of the first aspect, the training system further includes an effectiveness evaluation module for obtaining the learning status and position competency of the learners. The training plan generation module is also used to optimize the training plans based on the learners' learning status and position competency.

In an embodiment of the first aspect, the learners' position competency is described through one or more of the following dimensions: professional ability, execution ability, innovation ability, collaboration ability, and growth ability.

In an embodiment of the first aspect, the training system further includes an online training module for conducting training using virtual reality and/or augmented reality technologies based on the training plan, and/or for providing the learners with the latest course recommendations, general course recommendations, and/or personalized course recommendations.

In an embodiment of the first aspect, the training system further includes an interaction module and/or a training management module. The interaction module is used to provide a platform for learners to interact and communicate, and the training management module is used for visualizing the training status and/or course status, as well as setting up courses, managing academic programs, managing projects, and/or managing learners based on instructions.

In a second aspect, the present disclosure provides a training method for the survey and design field. The training method includes: obtaining learner data and training data in the survey and design field; generating a training knowledge graph based on the training data; generating learner portraits based on the learner data and course portraits based on the training courses in the survey and design field; and generating personalized training plans using an artificial intelligence model based on the learner portraits, course portraits, and the training knowledge graph.

In a third aspect, the present disclosure provides a computer-readable storage medium storing a computer program, wherein the computer program, when executed by a processor, implements the training method provided in the second aspect of the present disclosure.

In a fourth aspect, the present disclosure provides an electronic device. The electronic device includes a memory storing a computer program; and a processor communicatively connected to the memory. The processor executes the computer program to implement the training method provided in the second aspect of the present disclosure.

The present disclosure provide a training system for the survey and design field, which can generate personalized training plans using an artificial intelligence model based on learner portraits, course portraits, and the training knowledge graph.

The training system provided by the present disclosure can automatically adjust and optimize the training plans based on the learners' learning status and position competency, ensuring that learners can study at a pace that suits them.

The training system provided by the present disclosure can utilize virtual reality and augmented reality technologies to offer learners an immersive learning experience, thereby enhancing their interest and engagement in learning.

The training system provided by the present disclosure can monitor and evaluate the learners' learning status in real time through an intelligent evaluation module, providing timely feedback and suggestions to help learners identify and improve upon issues in their learning process.

The training system provided by the present disclosure supports multiple devices and platforms, allowing learners to study anytime and anywhere, thereby enhancing the overall learning experience.

### BRIEF DESCRIPTION OF DRAWINGS

FIG. 1 shows a schematic structural diagram of an electronic device in an embodiment of the present disclosure.

FIG. 2 shows a schematic structural diagram of a training system in an embodiment of the present disclosure.

FIGS. 3A and 3B show schematic diagrams of knowledge graphs in an embodiment of the present disclosure.

FIG. 4 shows a schematic diagram of a visualization of a position competency knowledge system in an embodiment of the present disclosure.

FIG. 5 shows a radar chart of five-dimensional abilities in an embodiment of the present disclosure.

FIG. 6 shows a structural diagram of an artificial intelligence model in an embodiment of the present disclosure.

FIG. 7 shows a flowchart of a training method in an embodiment of the present disclosure.

### REFERENCE NUMERALS

100 Electronic device
101,107 Processor
102 Output device
103 Input device
104 Memory unit
105 Communication interface
106 Storage medium
200 Training system
210 Data collection module
220 Knowledge graph construction module
230 Portrait generation module
240 Training plan generation module
S71~S74 Steps

### DETAILED DESCRIPTION OF THE INVENTION

The following specific examples are provided to illustrate the embodiments of the present disclosure, and those skilled in the art can easily understand other advantages and benefits of the present disclosure based on the content disclosed in this specification. The present disclosure can also be implemented or applied in various other specific embodiments, and the details in this specification can be modified or altered in different ways without departing from the spirit of the present disclosure. It should be noted that, where there is no conflict, the following embodiments and the features within these embodiments may be combined with each other.

It should also be noted that the illustrations provided in the following embodiments are merely schematic representations to explain the basic concept of the present disclosure, and the figures only show components relevant to the present disclosure rather than the actual number, shape, and size of the components in practical implementation. The actual forms, quantities, and proportions of the components during implementation may be altered as needed, and the component layout may also be more complex.

The embodiments of the present disclosure provide a training system for the survey and design field, which achieves digitization of the training process, data-driven learning, measurable outcomes, visualized growth, and verifiable results by using platform functions.

Additionally, this training system is designed to achieve good training outcomes by constructing, for example, data insights, needs analysis, project design, metric definition, progress monitoring, process service, outcome presentation, and performance tracking on the basis of three main objectives of learning effectiveness, business performance, and talent development. The following is a detailed description of the technical solutions in the embodiments of the present disclosure, in conjunction with the accompanying drawings.

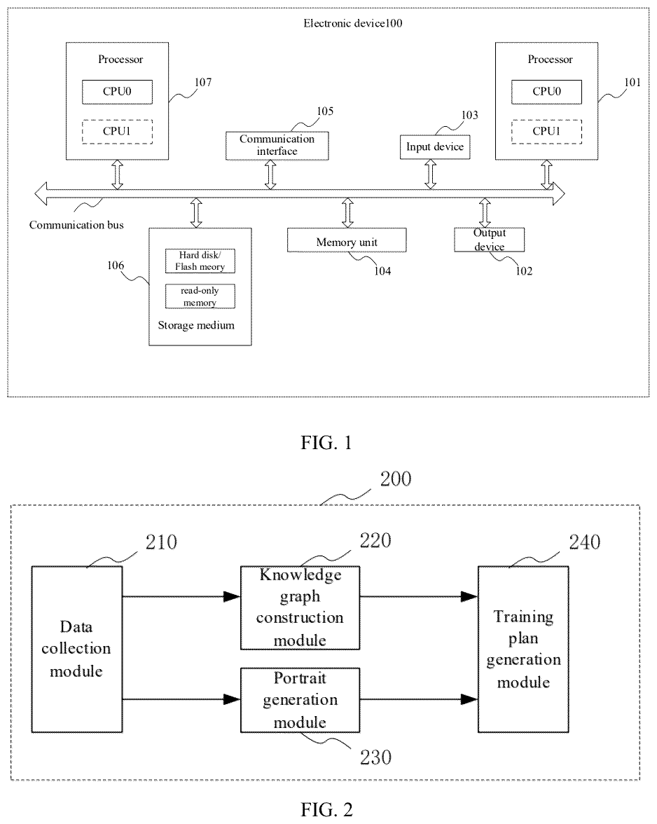

FIG. 1 shows a schematic structural diagram of an electronic device 100 in an embodiment of the present disclosure. The training system provided by the embodiments of the present disclosure may be applied to this electronic device 100. As shown in FIG. 1, the electronic device 100 includes a processor 101 connected to one or more data storage units. The data storage units may include a storage medium 106 and a memory unit 104. The storage medium 106 can be read-only, such as Read-Only Memory (ROM), or it can be readable and writable, such as a hard disk or flash memory. The memory unit 104 may be Random Access Memory (RAM). The memory unit 104 may be integrated with the processor 101 or be a separate component. The processor 101 is the control center of the electronic device 100 and is used to execute program code to perform the functions corresponding to the program instructions. In some embodiments, the processor 101 includes one or more Central Processing Units (CPUs), such as CPU0 and CPU1 shown in FIG. 1. In some embodiments, the electronic device 100 includes more than one processor, such as processor 101 and processor 107 shown in FIG. 1. The processors 101 and 107 may be single-core or multi-core processors. It should be noted that the term “processor” as used herein refers to one or more devices, circuits, and/or processing cores that process computer program instructions and other data.

The CPUs of the processors 101 and/or 107 store the program code to be executed in the memory unit 104 or in the storage medium 106. In some embodiments, the program code stored in the storage medium 106 can be copied to the memory unit 104 for execution by the processor. The processor controls the operation of the electronic device 100 by managing the execution of other programs, controlling communication with peripheral devices, and managing the resources of electronic device 100.

The electronic device 100 may also include a communication interface 105, through which the electronic device 100 can communicate directly or via an external network with another device or system.

In some embodiments, the electronic device 100 also includes an output device 102 and an input device 103. The output device 102 is connected to the processor 101 and is capable of displaying output information in one or more ways. An example of the output device 102 is a visual display device, such as a Liquid Crystal Display (LCD), Light-Emitting Diode (LED) display, Cathode Ray Tube (CRT), or projector. The input device 103 is connected to the processor 101 and is capable of receiving user input in one or more ways. Examples of the input device 103 include a mouse, keyboard, touchscreen device, sensor device, etc.

The aforementioned components of the electronic device 100 can be interconnected via one or more of buses, including data buses, address buses, control buses, expansion buses, and local buses.

The electronic device 100 can be a general-purpose electronic device or an application-specific electronic device. As a practical example, the electronic device 100 may be a storage array, application server, supercomputer, desktop computer, laptop, Personal Digital Assistant (PDA), mobile phone, tablet, wireless terminal device, telecommunication equipment, or any other device with a similar structure as shown in FIG. 1. However, the electronic device 100 in the present disclosure is not limited to any specific type of electronic device. When the program code stored in memory 104 is executed by the processor (processor 101 or processor 107), it forms processes. During process execution, the processor allocates a segment of memory space for each process to store the generated data. To facilitate data communication between processes, the processor (processor 101 or processor 107) typically forms a segment of memory, namely shared memory, and this shared memory is allocated to multiple processes that require data sharing. The processes in the embodiments of the present disclosure may be virtual machines, containers, or any other processes that require data sharing.

FIG. 2 shows a schematic structural diagram of a training system 200 in an embodiment of the present disclosure. The functions of the training system 200, either in whole or in part, can be implemented by the processor 101 and/or the processor 107. As shown in FIG. 2, the training system 200 may include a data collection module 210, a knowledge graph construction module 220, a portrait generation module 230, and a training plan generation module 240.

The data collection module 210 is used to obtain learner data and training data in the survey and design field. The learner data may include basic information and learning information of the learners. The learning information may include, for example, the relevant knowledge browsed by the learners and their operational behaviors. The training data in the survey and design field may include professional knowledge, technical specifications, case analyses, theoretical knowledge, practical experience, and other data, which can be obtained from professional books, papers, online resources, etc. The data collection module 210 facilitates the foundational collection of courses, data, and knowledge by gathering this training data.

The knowledge graph construction module 220 is used to construct a training knowledge graph based on the training data. The training knowledge graph uses structured knowledge representation methods to represent the training data in the survey and design field, thereby clearly displaying the structure and relationships of the data. The training knowledge graph includes nodes and edges, where nodes represent entities, and edges represent the relationships between the entities.

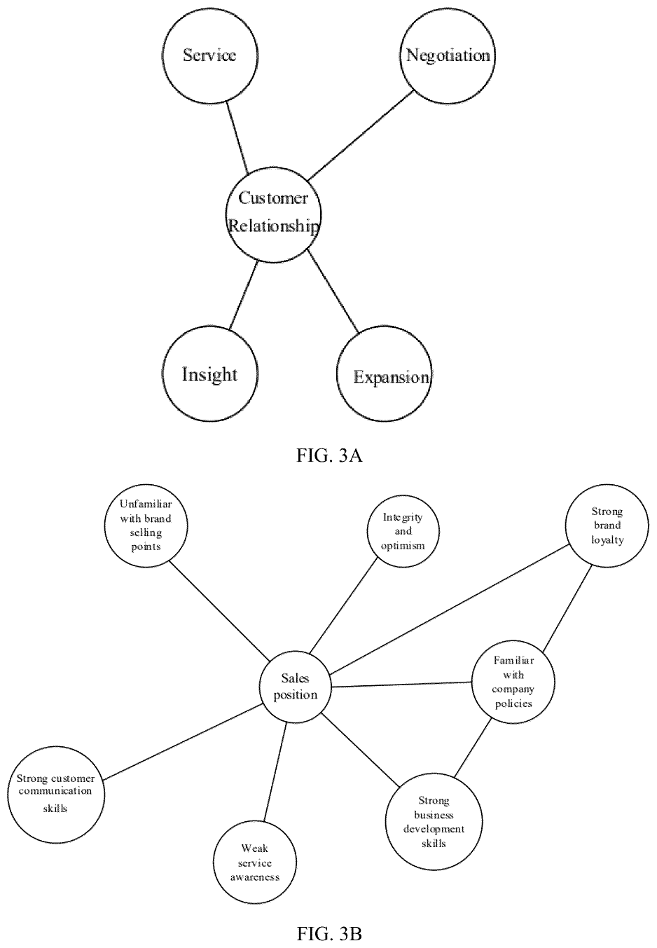

In some embodiments, the training knowledge graph may include a survey-and-design knowledge graph and a job-business knowledge graph. The survey-and-design knowledge graph is used to describe general knowledge in the survey and design field, while the job-business knowledge graph is used to describe the business knowledge specific to particular job roles. FIGS. 3A and 3B respectively show exemplary visualizations of the survey-and-design knowledge graph and the job-business knowledge graph.

In some embodiments, the system can perform online inference to identify the areas where learners have deficiencies in job-related knowledge and professional knowledge, and then highlight these deficiencies in the knowledge graph according to their level of importance. This allows learners to prioritize and address each deficiency through targeted learning, thereby achieving precise and personalized talent development.

The portrait generation module 230 is used to generate learner portraits based on learner data and course portraits based on the training courses in the survey and design field. The learner portrait is a model with multiple dimensions, which can describe the basic characteristics, behavior patterns, and preferences of the learners. The course portrait describes the training courses, including aspects such as course content, teaching methods, teaching materials, popularity, etc.

As an example, Table 1 shows an example of the dimensions of the learner portrait. As shown in Table 1, the learner portrait can include dimensions such as employee information, knowledge browsing records, and the employee's interaction with the training system. The employee information can include dimensions such as work experience, years of service, and search habits. The knowledge browsing records can include dimensions such as the basic attributes of knowledge documents, the knowledge base affiliation, and knowledge utilization evaluation information. The employee's interaction with the training system can include dimensions such as search terms, bookmarking behavior, and recommendation/evaluation behavior.

TABLE 1
Exemplary dimensions of a learner portrait

| | |
|---|---|
| Employee Information | Work experience, Years of service |
| | Search habit |
| | Hobbies |
| | Basic information |
| | Educational background |
| | Department affiliation |
| | Project experience, Research experience |
| | Professional area |
| | Awards and achievements |
| Knowledge | Basic attributes of knowledge |
| Browsing Record | documents |
| | Knowledge base affiliation |
| | Knowledge utilization evaluation |
| | information |
| Employee's Interaction | Search term |
| with the Training System | Bookmarking behavior |
| | Recommendation and evaluation |
| | behavior |
| | Click record |
| | Knowledge sharing and interaction |
| | behavior |
| | Knowledge outputs |

The training plan generation module 240 is used to generate personalized training plans using an artificial intelligence model based on learner portraits, course portraits, and the training knowledge graph.

As an example, the training plan generation module 240 can also refer to user browsing behavior, the names of the courses studied, the names of the courses viewed, training course categories, bookmarked training courses, course sharing behavior, and the training courses of colleagues in the same department or professional field to generate personalized training plans.

In some embodiments, the training plan generation module 240 can dynamically analyze the learner's knowledge acquisition based on their competency model, learning progress, and learning status, and then adjust the training content and methods flexibly.

In some embodiments, the training system can also include a data processing module, which is used to pre-process the data obtained by the data collection module to ensure the accuracy and completeness of the training knowledge. Moreover, by pre-processing the data, the precise recommendation of specific training courses and the construction of the training knowledge graph in subsequent steps can be improved.

As an example, the data processing module can perform tasks such as data cleansing, organizing training course content, and removing duplicate or irrelevant information from the data collected by the data collection module.

In some embodiments, the training system can also include a visualization module. The visualization module is used to visually present the learner portraits, course portraits, and/or the training knowledge graph. The forms of visualization include, but are not limited to, charts, pictures, animations, etc. Through effective visualization design, the knowledge graph that combines employees, projects, and professional areas becomes more intuitive and easier to understand, allowing users to comprehend and utilize it more effectively. By mapping the professional knowledge in the survey and design field and using visualization technologies for presentation, learners can more intuitively understand the relationships between different pieces of knowledge, thereby improving learning efficiency.

Additionally, the content presented by the visualization module can assist course developers in developing training courses for the survey and design field. These training courses may include theoretical knowledge courses, practical skill training courses, case analysis courses, etc. These courses can help learners quickly master the knowledge and skills related to their respective positions in the survey and design field.

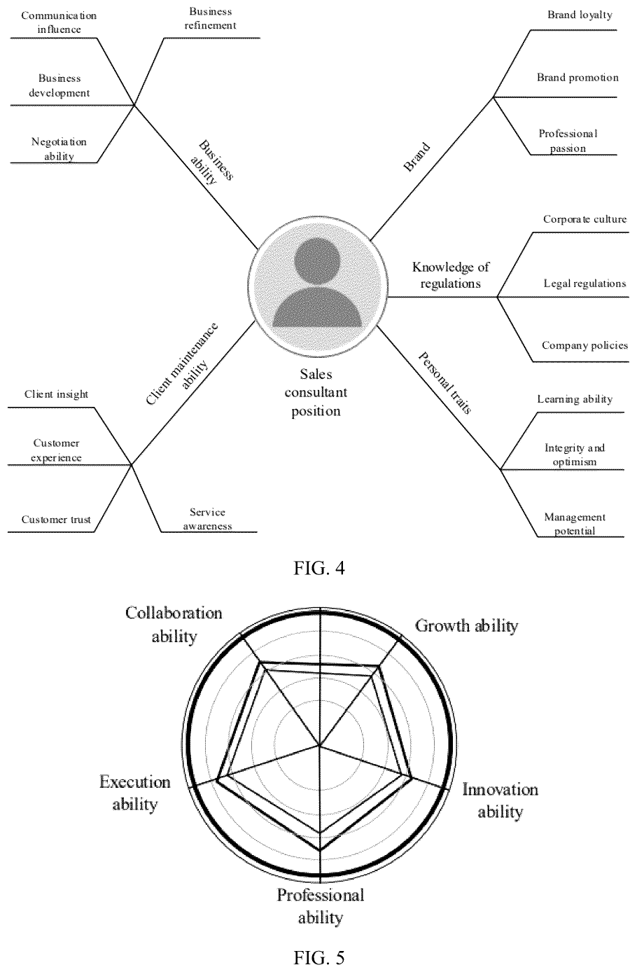

In some embodiments, the visualization module is also used to visually present the position competency knowledge system. FIG. 4 shows an exemplary visualization of a position competency knowledge system.

As shown in FIG. 4, learners can intuitively understand the skills required for different job positions and thereby engage in targeted learning.

In some embodiments, the training system may also include an online training module for implementing the training plans. Learners can select different knowledge points for study according to their needs.

Additionally, the online training module can be used to train learners using virtual reality and/or augmented reality technologies based on the training plans. This approach provides an immersive learning experience for learners, enhancing the enjoyment and engagement in learning.

In some embodiments, the online training module can also be used to provide learners with the latest course recommendations, general course recommendations, and/or personalized course recommendations, along with functions such as progress tracking and learning outcome evaluation, enabling learners to better tailor their learning according to their skill deficiencies.

In some embodiments, the training system may also include an effectiveness evaluation module. The effectiveness evaluation module is used to obtain information about the learners' learning status and position competency (that is, position-specific competency). The training plan generation module is also used to optimize the training plans based on the learners' learning status and competency levels, helping learners quickly improve their professional skills.

For example, the effectiveness evaluation module can assess the learners' learning status and position competency through methods such as exams, project practice, and surveys.

In embodiments of the present disclosure, the learners' position competency can be described using an employee competency evaluation model. The employee competency evaluation model is constructed based on the characteristics of the industry, the attributes of the company, and the traits of the talent. As shown in FIG. 5, the employee competency evaluation model can include one or more of the following dimensions: professional ability, execution ability, innovation ability, collaboration ability, and growth ability. For example, Table 2 shows a classification of the five-dimensional abilities. As shown in Table 2, professional ability includes mastery of technical tools, educational background, etc.; execution ability includes the number of projects participated in, personal work quality; innovation ability includes basic requirements, academic research ability, etc.;

collaboration ability includes work coordination performance, communication skill, etc.; and growth ability includes self-growth motivation, proactive talent development, etc.

TABLE 2
Classification of abilities

| Ability Dimensions | Classification |
|---|---|
| Professional Ability | Mastery of technical tools |
| | Educational background |
| | Professional certification |
| | Accumulation of practical experience |
| Execution Ability | Number of projects participated in |
| | Personal work quality |
| | Work execution efficiency |
| | Evaluation results |
| Innovation Ability | Basic requirements |
| | Academic research ability |
| | Industry influence |
| | Project innovation outcomes |
| Collaboration Ability | Work coordination performance |
| | Communication skills |
| | Compliance with company policies |
| | Alignment with company development direction |
| | Honors |
| Growth Ability | Self-growth motivation |
| | Proactive talent development |
| | Growth potential |
| | Achievement motivation orientation |

In some embodiments, the training system may also include an interaction module. The interaction module is used to provide a platform for learners to interact and communicate, enabling them to share learning experiences, discuss issues, and help each other, thereby improving learning outcomes. Combining the online training module with the interaction module can help learners better grasp knowledge and enhance the effectiveness of the training.

In some embodiments, the training system may also include a training management module. The training management module is used to visually present the training status and/or course status, and to set up courses, manage academic programs, manage projects, and/or manage learners based on instructions. Through the training management module, administrators can manage training resources, view the training rankings of all learners and the popularity of courses, and perform course setup, academic program management, project management, and/or learner management. The efficient management provided by the training management module can make the training process more organized and effective.

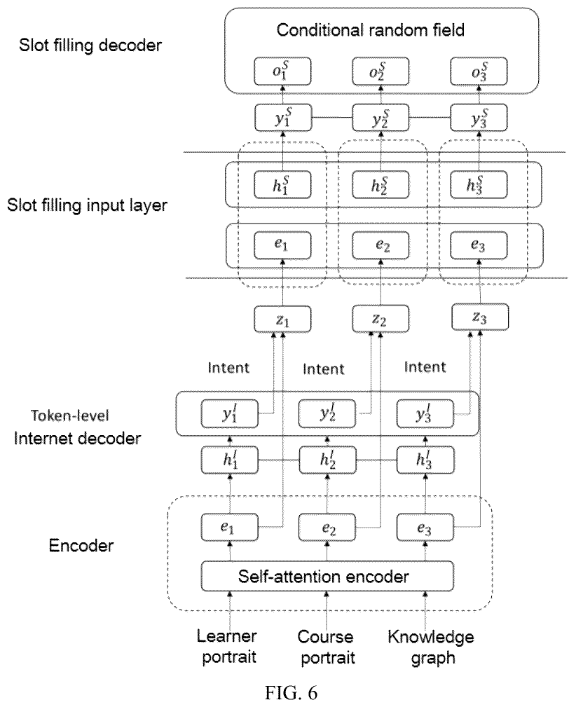

In some embodiments, the training plan generation module converts the learner portraits, course portraits, and training knowledge graphs into data formats acceptable by the artificial intelligence model, and then inputs the data into the artificial intelligence model. Based on the output of the artificial intelligence model, personalized training plans can be generated. FIG. 6 shows an exemplary diagram of an artificial intelligence model in an embodiment of the present disclosure. However, the present disclosure is not limited to thereto.

As described above, the present disclosure provides a training system for the survey and design field. This system utilizes artificial intelligence technology to perform personalized correlation algorithms based on each learner's learning status, competency level, learning style, and interests, as well as department, position, and the projects involved in their field. It also evaluates the learners' abilities from various dimensions, thereby providing personalized and customized training plans for each learner. This approach can enhance the learning outcomes of learners, improve training efficiency, and better meet the personalized learning needs of the learners. The system can be applied in practical scenarios such as online education, corporate training, vocational training, quality and safety, and technological innovation. It has been proven in practice that this system can help learners in the survey and design field more efficiently acquire knowledge and skills, thereby enhancing their personal competitiveness. At the same time, for companies in the survey and design field, this system can improve the quality and effectiveness of training, thereby reducing training costs.

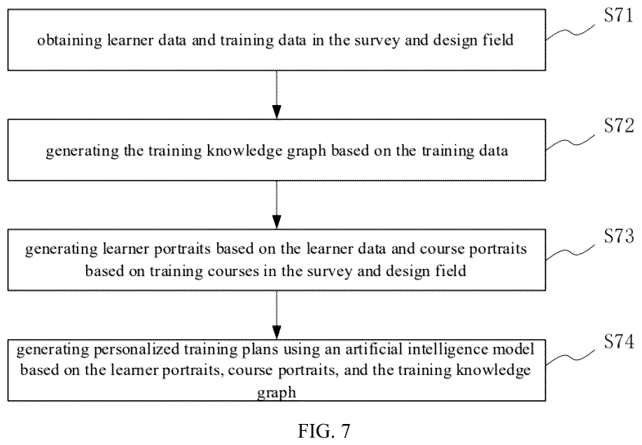

The present disclosure also provides a training method for the survey and design field. FIG. 7 shows a flowchart of a training method provided by an embodiment of the present disclosure. As shown in FIG. 7, the training method includes the following steps S71 to S74.

S71: obtaining the learner data and training data in the survey and design field.

S72: generating the training knowledge graph based on the training data.

S73: generating the learner portraits based on the learner data and course portraits based on the training courses in the survey and design field.

S74: generating personalized training plans using an artificial intelligence model based on the learner portraits, course portraits, and the training knowledge graph.

It should be noted that the above steps S71 to S74 correspond to the modules in the training system 200 shown in FIG. 2, and therefore, further elaboration is not provided here. Additionally, the protection scope for the training method provided by the embodiment of the disclosure is not limited to the sequence of steps listed in this embodiment. Any method implementation that involves adding, reducing, or replacing steps based on the principles of the present disclosure falls within the scope of the present disclosure.

The training method provided by the present disclosure maps the professional knowledge in the survey and design field into the knowledge graph and presents it using visualization technology. By combining the position competency model and the multi-dimensional correlation algorithm linking people, courses, specialties, and projects, learners' learning efficiency can be improved and the effectiveness of training can be enhanced.

It should be noted that the training system provided by the embodiment of the present disclosure can implement the training method provided by the embodiment of the present disclosure. However, the implementation apparatus for the training method is not limited to the structure of the training system described in the embodiments of the present disclosure.

Any structural modifications and replacements made based on the principles of the present disclosure fall within the protection scope of the present disclosure. Except for the various embodiments provided by the present disclosure, it should be understood that the disclosed systems, devices, or methods can also be implemented in other ways.

For example, the embodiments of the device described above are merely illustrative. The division of modules/units is only a logical division of functions, and in actual implementation, different division methods may be used. For example, multiple modules or units may be combined or integrated into another system, or some features may be omitted or not executed. Additionally, the coupling or communication connection shown or discussed between units may be indirect coupling or communication connection through some interfaces, devices, modules, or units, which can be electrical, mechanical, or other forms.

The modules/units described as separate components may or may not be physically separated. The components shown as modules/units may or may not be physical modules, i.e., they can be located in one place or distributed across multiple network units. Part or all of the modules/units can be selected to achieve the objectives of the embodiments of the present disclosure based on actual needs. For example, the functional modules/units in the various embodiments of the present disclosure can be integrated into one processing module, or the modules/units can exist independently as separate physical entities, or two or more modules/units can be integrated into one module/unit.

Those skilled in the art will further understand that the units and algorithm steps described in the embodiments disclosed herein can be implemented in electronic hardware, computer software, or a combination of both. To clearly illustrate the interchangeability of hardware and software, the compositions and steps of the various examples have been generally described according to their functionality in the above description. Whether these functions are executed in hardware or software depends on the specific application and design constraints of the technical solution. A skilled professional can use different methods for each specific application to implement the described functions, but such implementations should not be considered as exceeding the scope of the present disclosure.

The present disclosure also provides a computer-readable storage medium on which a computer program is stored. When executed by a processor, this computer program implements the training method provided by the embodiments of the present disclosure. Those skilled in the art will understand that all or part of the steps in the methods of the above embodiments can be carried out by a program that instructs the processor. The program can be stored on the computer-readable storage medium. The computer-readable storage medium may be a non-transitory medium, such as Random Access Memory (RAM), Read-Only Memory (ROM), flash memory, hard disk, solid-state disk (SSD), magnetic tape, floppy disk, optical disc, or any combination thereof. The aforementioned storage medium can be any medium that a computer can access, or data storage devices such as servers, data centers, etc., that integrate one or more accessible media. The accessible medium may be a magnetic medium (e.g., floppy disk, hard disk, magnetic tape), an optical medium (e.g., Digital Video Disc (DVD)), or a semiconductor medium (e.g., solid-state disk (SSD)).

The present disclosure also provides an electronic device. The electronic device includes a memory and a processor. The memory stores a computer program. The processor is communicatively connected to the memory and executes the training method provided by the embodiment of the present disclosure when the computer program is invoked.

The descriptions of the processes or structures corresponding to each of the above figures focus on different aspects. For parts of a process or structure not described in detail, reference can be made to the relevant descriptions of other processes or structures.

The above embodiments are provided solely to illustrate the principles and effectiveness of the present disclosure and are not intended to limit the scope of the present disclosure. Any person skilled in the art may modify or alter the above embodiments without departing from the spirit and scope of the present disclosure. Therefore, all equivalent modifications or alterations made by those skilled in the art, without departing from the spirit and technical concepts disclosed in the present disclosure, should be covered by the claims of the present disclosure.

1. A training system for the survey and design field, comprising:
a data collection module, configured to obtain learner data and training data in the survey and design field;
a knowledge graph construction module, configured to construct a training knowledge graph based on the training data;
a portrait generation module, configured to generate a learner portrait based on the learner data and to generate a course portrait based on training courses in the survey and design field;
a training plan generation module, configured to generate personalized training plans using an artificial intelligence model based on the learner portrait, the course portrait, and the training knowledge graph.

2. The training system according to claim 1 further comprising a data processing module, wherein the data processing module is configured to pre-process data obtained by the data collection module.

3. The training system according to claim 1 further comprising a visualization module, wherein the visualization module is configured to visually present the learner portrait, the course portrait, and/or the training knowledge graph.

4. The training system according to claim 1 further comprising an effectiveness evaluation module, wherein the effectiveness evaluation module is configured to obtain the learner's learning status and position competency, and the training plan generation module is further configured to optimize the training plans based on the learner's learning status and position competency.

5. The training system according to claim 4, wherein the learner's position competency comprises one or more of the following dimensions: professional ability, execution ability, innovation ability, collaboration ability, and growth ability.

6. The training system according to claim 1 further comprising an online training module, wherein the online training module is configured to train the learner using virtual reality and/or augmented reality technologies based on the training plans, and/or to provide the learner with the latest course recommendations, general course recommendations, and/or personalized course recommendations.

7. The training system according to claim 1 further comprising an interaction module and/or a training management module,
wherein the interaction module is configured to provide a platform for the learner to interact and communicate;
wherein the training management module is configured to visually present training status and/or course status, and to perform course setup, academic program management, project management, and/or learner management based on instructions.

8. A training method for the survey and design field, comprising:
obtaining learner data and training data in the survey and design field;
generating a training knowledge graph based on the training data;
generating a learner portrait based on the learner data and generating a course portrait based on training courses in the survey and design field; and
generating personalized training plans using an artificial intelligence model based on the learner portrait, the course portrait, and the training knowledge graph.

9. A computer-readable storage medium, with a computer program stored thereon, wherein the computer program, when executed by a processor, implements the training method according to claim 98.

10. An electronic device, comprising: a memory storing a computer program; and a processor communicatively connected to the memory;
wherein the processor executes the training method according to claim 98 when the computer program is invoked.
